(19) United States
(12) Patent Application Publication
(10) Pub. No.: US 2015/0110701 A1
(43) Pub. Date: Apr. 23, 2015

(54) BIOGENIC SILICA AS A RAW MATERIAL TO CREATE HIGH PURITY SILICON

(71) Applicants: Wadham Energy LP, San Ramon, CA (US); Mayaterials, Inc., Ann Arbor, MI (US)

(72) Inventors: Richard M. Laine, Ann Arbor, MI (US); Julien C. Marchal, Ann Arbor, MI (US)

(73) Assignees: Wadham Energy LP; Mayaterials, Inc.

(21) Appl. No.: 14/519,051

(22) Filed: Oct. 20, 2014

Related U.S. Application Data
(60) Provisional application No. 61/892,843, filed on Oct. 18, 2013.

(51) Int. Cl. C01B 33/021

(52) U.S. Cl. CPC C01B 33/021
USPC 423/349; 65/33.1

(57) ABSTRACT

A low cost process is provided for creating high purity silicon from agricultural waste, particularly rice hull ash. The process uses a series of chemical and thermal steps to yield high purity silica while using less energy and more efficient chemical processes. The high purity silicon features fewer impurities that negatively affect the use of high purity for PV cells and reduces capital and operating costs of processes to yield ultra-pure silicon.

### CROSS-REFERENCE TO RELATED APPLICATIONS

This application claims the benefit of U.S. Provisional Application No. 61/892,843 filed Oct. 18, 2013, which application is incorporated herein by reference.

This invention was made with Government support under Department of Energy Solar America Contract No. DE-FG36-08GO18009. The government has certain rights in this invention.

### BACKGROUND

There is worldwide interest in solar photovoltaic (PV) cells that efficiently convert the sun's energy into low cost electricity. A major cost of silicon-based PV solar cells is the extremely high purity silicon (Si) used in PV cells. A significant reduction in the cost of high purity silicon would reduce the price of PV cells and both expand their use and expand the applications in which PV cells are competitive with traditional sources of electricity. An important feature of the cost of high purity silicon is the raw material source and the inherent cost of the manufacturing processes that isolate and purify the silicon contained in the raw silicon-containing materials that are processed to yield the high purity silicon used in solar cells.

Most high purity silicon manufacturing processes use carbothermal reduction of quartz/carbon mixtures. The raw material components most often used are centimeter or greater sized quartz and carbon containing feedstocks that are reacted at temperatures upwards of 1900° C. (3450° F.) to yield silicon purities of 97 to 99%. Impurity levels of 1-3% are considered relatively high and the resulting silicon is only usable in low-value metallurgical industries. This type of low purity silicon is called “metallurgical grade” silicon or Siₘₑₜ because of these relatively high levels of impurities.

For PV cells (Siₚᵥ) and electronics grade (Si_{eg}) silicon, the required purities are typically greater than 99.999% (termed “five nines” purity) and often greater than 99.999999% (“eight nines” purity) respectively. These high purity requirements require expensive further purification steps that typically require a chemical reaction of lower metallurgical grade Siₘₑₜ with hydrochloric acid (HCl) to produce HSiCl₃ and SiCl₄. HSiCl₃ can be further reacted to produce SiCl₄ and SiH₄. SiH₄ is further decomposed in a second high temperature step, typically to produce electronics grade silicon of nine nines purity (Si_{eg}). The SiCl₄ can also be reacted with H₂ to produce HCl and SiH₄ or six nines or high purity solar grade silicon or Siₚᵥ, but the processes require extremely high temperatures and other energy intensive steps that significantly increase the cost of the overall process.

The necessity of using HCl gas and chlorosilanes in multiple high temperature steps, coupled with the need to recapture HCl and prevent release of chlorosilanes into the atmosphere during processing, results in major capital expenditures. Furthermore, these are energy intensive processes that add massive expense to the cost of producing high purity Si-based PV cells. Although earlier work by some scientists suggested the potential to avoid chlorosilane processing, these efforts did not result in actual production of high purity silicon from rice hulls.

As noted above, an important cost factor is the raw material source of the silicon used in the manufacturing and purification processes that yield high purity silicon. While sources such as sand and quartz rock are commonly used, agricultural products are also known to contain high quantities of raw and purse silicon. For example, a number of agricultural grains and grasses are known to concentrate silicon in their stalks and seed hulls and are, therefore, an attractive source of silicon because the seed hulls and stalks are waste products that are created when other useful parts of the plant are processed to produce food products. Also, some agricultural waste products, such as rice hulls, are further processed i.e., burned to produce energy and the resulting inorganic byproduct, such as rice hull ash, contains many of the valuable original inorganic components such as silica. However, the byproduct also contains other impurities that require extensive chemical processing and purification steps to recover the desired silicon at high purities.

Very significant differences exist in the processing and purification processes between rice hull (RH) and rice hull ash (RHA). RHA impurities are more reactive with acids than those in RH. While this difference results in much higher purities following acid leaching, the difference in reactivities also requires different chemical processing steps to efficiently remove undesired impurities. In addition, while existing processes attempt to produce high purity silicon using rice hulls and/or group II metal reductants, there is no evidence that existing processes successfully produce high purity silicon having both the physical and chemical properties useful in applications that require extremely high purity silicon (5 nines and higher) and having only a minimal presence of certain key contaminants or impurities.

Accordingly, a need exists to develop a low cost, low energy process for 1) purifying RHA, (2) converting the purified RHA into polycrystalline silicon using carbothermal reduction, and 3) controlling the impurities during the process to meet or exceed the standards for high quality photovoltaic cells, such as solar silicon feedstock (SEMI III).

### SUMMARY OF INVENTION

The current invention includes a method of producing high purity silicon using biogenic silica sources including grasses (wheat, rice, barley, oats, etc.) that take up SiO₂ in their stalks and seed hulls with minimal incorporation of the standard impurities found in “high purity quartz” as well as diatomaceous earth from diatoms. Thus the plants and diatoms naturally pre-purify the silica incorporated in their structure. Rice hulls (RH) have the highest silica content of all the grasses and are used as the example of a this patent in the form of rice hull ash (RHA). However, other forms of biogenic silica may be utilized in the same fundamental process.

The invention includes processing steps that reduce energy, reduce cost of materials, and reduce processing times using each of selected reagents, techniques and materials that individually improve the process from raw source material to final product. The process steps include selection of raw source material, milling of raw materials, specifically agricultural waste, and more specifically biogenic waste, such as rice hull ash (RHA), with acid to recover a purified intermediate silicon product. Several washing steps to are used further purify the silicon products and remove impurities. The further processing of acid-leached biogenic silica products with a catalytic base, and optionally a glycol, such as ethylene glycol or other diol to reduce silica content, is used to adjust the final SiO₂:C ratio. Processing a purified biogenic silica product at high temperatures, typically in an electric arc furnace, combined with isolating molten silicon having purities of at least 99.99% purity, and also at least 99.999% and at least 99.9999% yields high purity silicon. Moreover, the resulting high purity silicon can be cast in molds allowing directional solidification/crystallization providing improved purities greater than 99.9999% (six nines purity).

This invention is the first demonstration that high purity silicon can be produced from biogenic silica, especially in the form of RHA, and specifically a high purity silicon having a purity greater than 99.99 wt. % purity and preferably closer to 99.9999 wt. % purity. Such high purity silicon is produced to specified purity values and absent threshold values for specific impurities. The resulting silicon products are conclusively and quantitatively demonstrated to meet the requirements of high purity and low contaminants. Still further, the processes described herein require less energy and are kinetically much faster than traditional electric arc furnace processing of Siₘₑₜ because of the intimate mixing (at 100 nm length scale) of SiO₂ and carbon in the RHA and other biogenically derived materials.

This invention is the first demonstration that high purity silicon can be produced from biogenic silica, especially in the form of RHA, and specifically that a high purity silicon can be produced from these raw materials resulting in a final purity greater than 99.99 wt. % purity, and greater than 99.9999 wt. % and preferably greater than 99.99999% and 99.999999 purity. Such high purity silicon is produced to yield specified silicon purity values and also absent threshold values for specific impurities that reduce the value of the resulting product. the resulting silicon products are conclusively and quantitatively demonstrated to meet the requirements of high purity and low contaminants needed for specialty photovoltaic and other applications. Still further, the process described herein require less energy and are kinetically much faster than traditional electric arc furnace processing of Siₘₑₜ because of the intimate mixing (at 100 nm length scale) of SiO₂ and the carbon in the RHA and other biogenically derived materials.

The invention also includes intermediate, partially purified silicon-containing compositions having characteristic components that result from the processes described herein and the selections of the raw material source and other parameters, including but not limited to C:SiO₂ ratios, densities, particle sizes, and absolute and combination profiles of impurities including but not limited to Aluminum, Boron, Calcium, Chromium, Copper, Iron, Magnesium, Manganese, Potassium, Sodium, and Phosphorus.

The invention may be also defined by final high purity silicon products having characteristic high purity levels for silicon and characteristic levels of impurities or combinations thereof including levels of impurities below threshold values usable in applications such as PV cells.

### DESCRIPTION OF THE FIGURES

FIG. 1 is a schematic of a prior art silicon purification process using rice hulls (RH) as the source raw material, generally in accord with Amick et al. U.S. Pat. No. 4,214,920 (1980).

FIG. 2 is a schematic of a process to produce high purity silicon from rice hull ash (RHA) according to the present invention.

### DETAILED DESCRIPTION OF INVENTION

Impurity levels for rice hulls harvested from around the world are known to be relatively similar. A number of prior art processes have been developed both to increase the purity of the silicon end-product and to remove impurities that impede performance of high purity silicon in PV and other electronic applications requiring high purity silicon. Prior art processes leach impurities by rinsing RHA with water five times followed by boiling in HCl:H₂O at varying ratios and then washing with electronics grade water, per Table 1 columns 2-9 from left to right and Table 2. Thereafter, coking the rice hulls at 900° C. (with considerable evolution of gases and smoke) in flowing Ar/I % HCl (Table 1 column 10) forms a material with a C:SiO₂ ratio of 4:1 while keeping low impurity contents (Table 1 column 10) or even reducing impurities (relative to silicon content) by as much as 97 wt. % (Table 2c). In a fourth step, this material is further coked at ≈950° C. in flowing CO₂ to adjust the C:SiO₂ ratio to ≈2:1. In a fifth step, the feedstock in a particulate form is fed continuously into an electric arc furnace (EAF) heated to keep the walls at ≈1900° C. and thereafter the furnace is cooled allowing recovery of the purified Silicon. Note that the “Coked” HCl in column 10 in Table 1 is a 900° C. treatment with gaseous HCl, considerably increasing the cost of such processes in terms of the number of steps and the capital equipment needed to contain high temperature HCl.

In this prior art process, the coked RH is fed into the furnace in pellets formed using sucrose binders, leading to the results in Table 3a. Table 3b lists projected Si impurities, although absolute values for the projected impurities have not been quantitatively measured in these experiments.

TABLE 1
Prior Art Amick et al characterization of RHs after specific treatments.
EMISSION SPECTROGRAPHIC ANALYSES OF RAW AND CLEANED RICE HULLS

| | | Processing Steps | | | | | | | | |
|---|---|---|---|---|---|---|---|---|---|---|
| | | | | | | Previous | Previous | | | |
| | | | | | | Clean | Clean | | | |
| | | | | Rinses | Rinses | Plus 1:1 | Plus 1 Hr. | 1:3 HCl:H₂O | | 1:1 HCl:H₂O |
| | | Raw | 5X | Plus | Plus 1:3 | HCl:H₂O | Soak in | Plus 1:1 | Duplicate | Boiled 1 Hr. |
| | | Rice | Distilled | HCl | HCl:H₂O | Boiled | Distilled | HCl:H₂O | of Previous | Plus Coked |
| | | Hulls | Water | Aqueous | Boiled | 20 Mins. | Water | Plus SC-2 | Sample | in 1% HCl |
| | | (La.) | Rinses | Cleaning | 1 Hour | | | 20 Min. Hot | | in Argon |
| | | | | | | Double | Acid | | HCl/H₂O₂ | |
| | | Raw | Water | Acid | Acid | Acid | Water | HCl/H₂O | Cleaned | HCl |
| | Impurities | Hulls | Washed | Cleaned | Cleaned | Cleaned | Soak | Cleaned | Duplicate | Coked |
| Dopants | B | 10 | 40 | — | 10 | 10 | 10 | 10 | 10 | 5 |
| | Al | 200 | 900 | 100 | 100 | 60 | 50 | 200 | 100 | 10 |
| | N.D. | Present | N.D. | N.D. | N.D. | N.D. | N.D. | N.D. | N.D. | N.D. |
| Lifetime | Cr | N.D. | N.D. | N.D. | N.D. | N.D. | N.D. | 10 | 40 | N.D. |
| Killers | Mn | 1500 | 1600 | 50 | 30 | 30 | 40 | 40 | 30 | 10 |
| | Fe | 900 | 700 | 30 | 50 | 40 | 30 | 40 | 30 | 10 |
| | Cu | 10 | 20 | N.D. | N.D. | N.D. | N.D. | N.D. | N.D. | N.D. |
| | Ni | N.D. | N.D. | N.D. | N.D. | N.D. | N.D. | N.D. | N.D. | N.D. |
| Mobile | Na | 400 | 600 | 70 | 10 | 10 | 10 | 10 | 30 | 10 |
| Ions | K | — | 2000 | — | 30 | 10 | 10 | 20 | 20 | 10 |
| | Li | — | N.D. | — | N.D. | N.D. | N.D. | N.D. | N.D. | N.D. |
| | Mg | 3000 | 2200 | 50 | 60 | 60 | 60 | 60 | 80 | 20 |
| | Ca | 4000 | 6300 | 50 | 70 | 50 | 70 | 60 | 70 | N.D. |
| Miscellaneous | Ti | 20 | 200 | 10 | 60 | 60 | 60 | 70 | 200 | N.D. |
| | Zn | — | N.D. | — | N.D. | N.D. | N.D. | N.D. | N.D. | N.D. |
| | Pb | — | 10 | — | N.D. | N.D. | N.D. | N.D. | N.D. | N.D. |
| | Mo | N.D. | N.D. | N.D. | N.D. | N.D. | N.D. | N.D. | N.D. | N.D. |
| | Pd | N.D. | N.D. | N.D. | N.D. | N.D. | N.D. | N.D. | N.D. | N.D. |
| Total | | 10,040 | 14,620 | 360 | 420 | 330 | 340 | 520 | 580 | 75 |

TABLE 2
Prior Art Amick et al characterization of RH impurities after specific treatments.
a

| T (h) | 0.25 | 0.25 | 5.0 |
|---|---|---|---|
| Ratio (HCl:H₂O) | 1:3 | 1:10 | 1:10 |
| Temp. (° C.) | Boil | Boil | 50 |
| Impurity* | Concentration (ppmw) | | |
| Al | 40 | 40 | 20 |
| B | 1 | 1 | <1 |
| Ca | 30 | 20 | 150 |
| Fe | 4 | 4 | 15 |
| K | 5 | 5 | 200 |
| Mg | 15 | 5 | 90 |
| Mn | 5 | 3 | 50 |
| Na | 10 | 5 | 15 |
| Ti | 1 | 5 | 5 |

b
Average from preceding tables

| Impurity* | | | Leached/ | Coked |
|---|---|---|---|---|
| (ppmw) | Raw | Leached | coked | only |
| Al | 10 | 10 | 50 | 50 |
| B | 2 | 1 | 0.7 | 10 |
| Ca | 1000 | 23 | 20 | >1000 |
| Fe | 20 | 20 | 10 | 200 |
| K | 3800 | 30 | 90 | >1000 |
| Mg | 500 | 10 | 40 | 1700 |
| Mn | 350 | 3 | 20 | 1000 |
| Na | 25 | 9 | 20 | 10 |
| P | 130 | 40 | 40 | 20 |
| S | 40 | 5 | 20 | <1 |
| Ti | 3 | 9 | 2 | 10 |

| | | Rice | Water | 1:3 aqueous | 1:1 aqueous | HCl |
|---|---|---|---|---|---|---|
| | Impurities | hulls | washed | HCl cleaned | HCl cleaned | coked |
| Dopants | B | 10 | 40 | 10 | 10 | 5 |
| | Al | 200 | 900 | 100 | 60 | 10 |
| | P | N.D. | Present | N.D. | N.D. | N.D. |
| Lifetime killers | Cr | N.D. | N.D. | N.D. | N.D. | N.D. |
| | Mn | 1500 | 1600 | 30 | 30 | 10 |
| | Fe | 900 | 700 | 50 | 40 | 10 |
| | Cu | 10 | 20 | N.D. | N.D. | N.D. |
| | Ni | N.D. | N.D. | N.D. | N.D. | N.D. |
| | Ti | 20 | 200 | 60 | 80 | N.D. |
| | Zn | — | N.D. | N.D. | N.D. | N.D. |
| | Mo | — | — | — | — | — |
| Mobile ions | Na | 400 | 600 | 10 | 10 | 10 |
| | K | — | 2000 | 50 | 10 | 10 |
| | Mg | 3000 | 2200 | 80 | 60 | 20 |
| | Ca | 4000 | 6300 | 70 | 50 | N.D. |
| Miscellaneous | Pb | — | 10 | N.D. | N.D. | N.D. |
| | Pd | — | — | — | — | — |
| Total (Other than Si) | | 10,040 | 14,820 | 420 | 330 | 75 |
| Residue (Ash) | | | 13.99% | 13.58% | 10.82% | 55.74% |

*Other impurities <1 ppmw.

TABLE 3
Prior Art Characterization of impurities (a) Pellets produced with
sucrose binder and coked, (b) PROJECTED final Si impurity levels.

| Sample | Sucrose | | Relative |
|---|---|---|---|
| no. | (%) | Density | strength |
| 8 | 12 | 816* | Low |
| 4 | 13 | 816* | Low |
| CRP-3 | 15 | 1.44** | Medium |
| 7 | 17 | 784* | Medium |
| CRP-2 | 21 | 1.35** | High |
| CRP-1 | 32 | 1.17** | High |

Conc. in silicon (ppmw)

| Impurity | Coked-only hulls | Leached/coked hulls |
|---|---|---|
| Al | 40 | 40 |
| B | 7 | 0.5 |
| Ca | >500 | 10 |
| Fe | 160 | 8 |
| P | 3 | 6 |
| Ti | 8 | 2 |

*Bulk (g/l),
**Actual (g/cm³).

In the process described herein, the preferred biogenic silica source is rice hull ash (RHA) typically having a density of between about 1.5-2.0 g/cc, which is less voluminous than rice hulls (0.7-1.1 g/cc), thereby minimizing the capital equipment and transport expense for a given mass of material.

The following steps disclose the basic advantages of the process steps of the present invention. The steps are susceptible of standard revisions known to those skilled in the art based on known process and energy input considerations. The first step in the process of the invention extracts impurities with dilute HCl solution and washes with distilled water, but at lower acid concentrations compared to prior processes.

In this step, RHA is milled in acid to remove impurities. Rice hull ash is milled in dilute acid for 3-120 hours preferably from 12 to 72 hours and most preferably from 24 to 48 hours at a pH preferably less than about 5, and then washed with two equal volumes of water with vigorous agitation and then with an equal volume of boiling water after filtration to remove acid. Following additional, water washes, the milled RHA is then subjected to catalytic base/ethylene glycol or other diol described in U.S. Publication No. US2013/0184483 A1, Jul. 18, 2013 publication date, to reduce silica to carbon ratios. The step of working lower purity silicon products with water preferably is comprised of washing with at least 2 aliquots of water having incongruous temperatures and the intermediate product is molded wet. Table 4 reveals the utility of milling in lower acid concentrations and the importance of washing with water after each step using acid. A boiling water wash (BWW) is an added important step that provides much lower impurities without high temperature (900° C. HCl) treatments.

Acid milling removes most impurities efficiently, but one important aspect is that impurities dissolve in acid solution can re-absorb. Water washed after milling remove re-absorbed species, often in amounts comparable to those initially removed by milling. Also while RHA contains significant phosphorous as phosphates, the high solubility of phosphates in dilute acid reduces the presence below detectable levels early in the process. Also, while potassium is present as a mixture of potassium oxide, hydroxide and carbonate, all three compounds are very soluble in dilute acid and are effectively removed in the early processing steps.

By requiring much less concentrated acids, purification of RHA by the processes disclosed herein is much more cost effective than existing techniques. As measured per unit of contained silica purified, the RHA purification process described herein requires 5 time less acid. Accordingly, at equivalent size, the processing equipment can purify RHA at 5 times the rate of RH. Additionally, RH acid extraction leads to an undesirable wet product that must be dried prior to conversion to RHA, thereby consuming more energy and resulting in a significant loss of net energy.

TABLE 4

| | | | | | | | | | | | | | | | | Total |
|---|---|---|---|---|---|---|---|---|---|---|---|---|---|---|---|---|
| Ppm | Al | B | Ca | Cr | Cu | Fe | Li | Mg | Mn | Ni | K | Na | Ti | P | Zn | ppmw |
| RHA/raw | 340 | 16 | 1200 | <1.0 | 4.8 | 350 | ND | 750 | 260 | ND | 11400 | 260 | 0.2 | 2100 | 50 | 16732 |
| after milling | 140 | 5 | 190 | <1.0 | 1.2 | 240 | ND | 210 | 60 | ND | 1300 | 35 | ND | 10 | 0.3 | 2193 |
| after cold wash | 64 | 4 | 76 | <1.0 | 0.5 | 110 | ND | 40 | 22 | ND | 150 | 5 | ND | ND | ND | 473 |
| after hot wash | 64 | 4 | 45 | <1.0 | 0.5 | 45 | ND | 32 | 20 | ND | 80 | 5 | ND | ND | ND | 297 |
| After BWW | 12 | 2 | 21 | ND | ND | 14 | ND | 8 | 8 | ND | 10 | 3 | ND | ND | ND | 78 |
| Complete process | 1 | 1 | 11 | ND | ND | 2 | ND | 5 | 2 | ND | 6 | 3 | ND | ND | ND | 31 |

Table 4. Various simple treatments of RHA to remove impurities. Raw; after milling in 3.7 wt. % HCl (1:10 HCl:H₂O); after milling in 3.7 wt. % HCl then water washed; after milling in 3.7 wt. % HCl then hot water washed; after milling in 3.7 wt. % HCl then boiling water washed (BWW) under reflux overnight; after milling in 3.7 wt. % HCl, then displacement washed, then leached in boiling acid (6.2 wt %) under reflux overnight, then boiling water washed (BWW) under reflux overnight (Complete process). Data presented in ppmw, carbon not included.

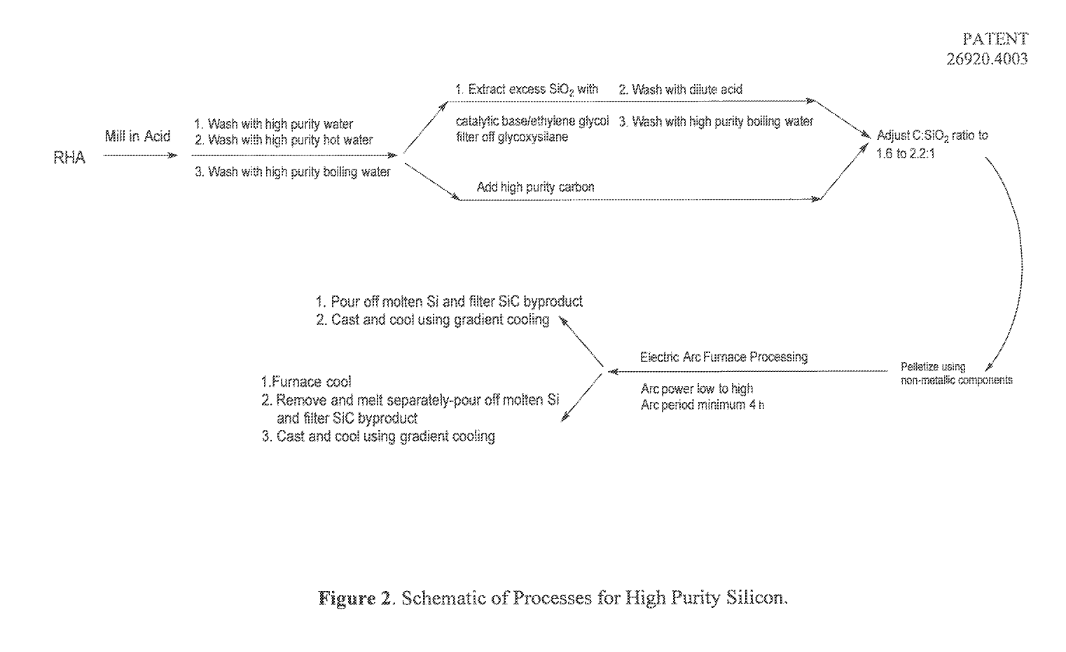

In the next step, purified RHA is further processed by either of two paths. (See FIG. 2). In a first and simpler path, high purity carbon (preferably graphite powder) is added to the purified RHA to adjust the C:SiO₂ to ≈2:1. Addition of fine carbon powder preferably adjusts the C:SiO₂ ratios to less than 2.1:1 and including ranges of from 1.4:1 to 2.1:1, preferably 1.6:1 to 2.0:1 and most preferably 1.65:1 to 1.9:1, and this mixture is carbothermally reduced in an electric are furnace (EAF) or an induction furnace. In a second path, the C:SiO₂ ratio of the purified RHA is adjusted by extraction with ethylene glycol or some other diol and catalytic amounts of base as described in U.S. Pat. No. 8,475,758, which is specifically incorporated by reference herein.

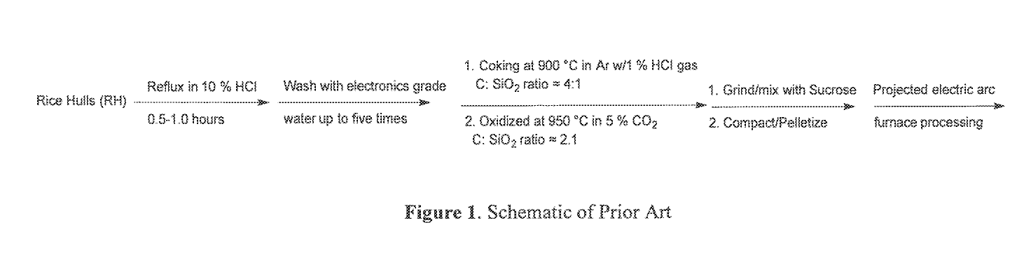

This extraction method of U.S. Pat. No. 8,475,758 currently requires 6-20 hours to remove 20-50% of the silica to adjust the C:SiO₂ ratio to near 2:1. Removing significant amounts of SiO₂ generates higher porosity allowing further purification with follow-on acid reaction and BWW. Optimally the silica extraction follows acid milling and a simple water wash of the RHA. Thereafter, a further impurity extraction step with dilute acid, followed by hot and more preferably a BWW wash, eliminates the need for the 1% HCl/Ar step used in the prior art process described in FIG. 1. The purities in the “complete process” of Table 4 are superior to those of Table 1, column 10.

The next step is EAF carbothermal reduction to produce Siₚᵥ as discussed below. It should be noted that purified RHA and purified silica depleted RHA (SDRHA) can be formed into pellets without the use of the binders, e.g. sucrose, that were the standard practice in the prior art.

Referring again to FIG. 2, this process avoids the two high temperature steps shown in FIG. 1, e.g. coking and carbon oxidation, and avoids the low temperature sucrose addition step. The process of the invention as shown in FIG. 2 adds either carbon powder or an extraction step for adjusting C:SiO₂ and an additional HCl wash that obviates a costly 900° C. 1% HCl/Ar step/coking step. The impurities in the silicon produced in this process can be further reduced by directional solidification and/or a conventional Czochralski recrystallization before the resulting product is used to make silicon boules. These two paths also avoid the Siemens process entirely, greatly reducing anticipated Siₚᵥ costs.

The fixed costs of the process described in FIG. 2 are significantly less than the prior art process of FIG. 1. Specifically, the invention facilitates more efficient materials handling because the volume of the raw silica source (RHA vs. RH) is less. Shipping costs are lower and the capital costs for the chemical reactors and processing equipment is lower. While the process of FIG. 1 is energy intensive and costly, the production of RHA from RH used in the process generates energy equal or in excess of the energy required by the rest of the process.

In addition, RHA is available with a wide range of C:SiO₂ ratios, from 5:95 to 40:60 (Agrielectric of Lake Charles, La., USA produces pelletized RHA having a defined C:SiO₂ ratio 5:95 or at custom values selected by the purchaser); (Producers Mills RHA has a 40:60 ratio requiring less extraction to reach 2:1 ratios). The total silica content is higher than the desired amounts with respect to the carbon content present. If a catalytic base is used, then the resulting mixture is again filtered and the recovered material washed with dilute acid and then water or boiling water to eliminate residual base and the resulting material is then pelletized using components that are not plastic, plastic coated metal or ceramic or ceramic coated metal pellizing machines.

The average particle size of the molded pellet components are 0.5-2000 μm and are most preferably between about 0.05 to 10 μm. The pellets have densities of 0.7 g/cc to 2.0 g/cc, and most preferably between about 1.2 to 1.8 g/cc. The pellets have a diameter of 0.5 to 10.0 cm, and most preferably between about 2-5 cm.

Carbothermal (EAF) Reduction.

Carbothermal reduction of SiO₂ to Si in intimate mixtures with C commences at ≈1400° C.; however, SiC is the primary product if carbon is in large excess and only rapid heating in an arc or induction furnace can drive direct reduction to Si. The EAF temperature is preferably in the range of 1400° to 2100° C. and more preferably between about 1500° to 1900° C., and most preferably between about 1600° to 1850° C. The time of electric are furnace processing is for periods of 4 to 72 hours, more preferably times of 6-48 hours, and most preferably times of 10-40 hours. However, these are suggested times and are meant to be exemplary and not limiting. The data herein establish that the invention provides high purity Si and eliminates or reduces cross-contamination from extraneous EAF components which are a primary source of residual impurities.

Table 5. Comparison of KHUA impurity content and corresponding impurity level in the silicon produced for that Batch. All purities are metal based and by weight (ppm by weight, ppmw).

TABLE 5

| | Batch | Si | Batch | Si | Batch | Si | Batch | Si | Si * | SEMI |
|---|---|---|---|---|---|---|---|---|---|---|
| ppmw | 1 | impurities | 2 | impurities | 3 | impurities * | 4 | impurities | impurities | III** |
| Al | 180 | 0.7 | 350 | 3.5 | 1600 | 0 | 350 | 0 | 0.1 | 0.3 |
| B | 28 | 0.4 | 53 | 0.0 | Unk | 0.2 | 15 | 0.1 | 0.05 | 0.1 |
| Ca | 840 | 0.3 | 1400 | 10.9 | 5250 | 0.2 | 1400 | 0.2 | 0.3 | 0.1 |
| Cr | <1.0 | 0.5 | 1.2 | 0 | Unk | 0.05 | <1.0 | 0.05 | 0 | 0.2 |
| Cu | 4.6 | 0 | 8.3 | 0 | Unk | 0 | 4.6 | 0 | 0 | 0.2 |
| Fe | 190 | 12.7^{†} | 330 | 5.6^{†} | 1400 | 4.3^{†} | 340 | 2.0^{†} | 0.1 | 0.2 |
| Mg | 530 | 0.05 | 850 | 10.6 | 2400 | 0.03 | 740 | 0 | 0.01 | 0.1 |
| Mn | 160 | 1.0 | 240 | 7.5 | 1050 | 0.5 | 260 | 0.2 | — | 0.2 |
| K | 10000 | 0.5 | 20000 | 67.3 | 33800 | 0.4 | 11000 | 0.2 | 1.2 | 0.1 |
| Na | 250 | 0 | 410 | 2.7 | 650 | 0 | 260 | 0 | 0.4 | 0.1 |
| P | 2100 | 0 | 5000 | 0 | 1050 | 0 | 2000 | 0 | 0 | 0.05 |
| % Purity | 98 | 99.998 | 97 | 99.98 | 95 | 99.9994 | 98 | 99.9997 | 99.9997 | 99.999** |

* Second run, batch 4
**SEMI standard also contains heavy metal impurities not discussed here (as RHA and Si made from RHA do not contain heavy metals).
^{†}Cross contamination from metal holders for electrodes.

The process may be supplemented by automated addition of 2:1 C:SiO₂ pellets or other ratios that allow control of the Si production rates over periods of from 1-40 h such that continuous reduction is achieved such that molten silicon is produced and remains molten over the period of addition.

Table 6 provides data for process optimization from minimizing cross-contamination. For example, pyrex glass reactors are pre-rinsed with hot 3.75 wt % HCl prior to introduction of milled and BWW washed RHA to minimize contamination from the borosilicate glass surface. This reduces the Boron and Aluminum content impurity, but Aluminum impurities from the furnace bricks are still thought to cause residual cross contamination. The purities observed in Tables 5-6 are prior to any effort to recrystallize the resulting silicon, which is anticipated to produce up to 8 Ns purities depending on the method of recrystallization used.

The process of isolating molten silica is comprised of decanting or filtrating molten silicon from by-product SiC with casting into heated molds, cooling the molds along a gradient to induce a crystallization front from one end to the other end of the mold. This technique drives and concentrates the impurities in front of the crystallization front leading to one end of the cooled, molded silicon having higher concentrations of impurities than all of the remaining silicon such that this silicon end can be cut off for recycling.

Table 6. Impurities in last EAF produced silicon sample (all numbers based on metal purity so C is not taken into account).

TABLE 6

| | Si impurities | Si impurities | Si impurities | Si impurities | |
|---|---|---|---|---|---|
| | ppmw | ppmw | ppmw | ppmw | SEMI III |
| ppm | Experiment #1 | Experiment #2 | Experiment #3 | Experiment #4 | Standard |
| Al | 0 | 0.2 | 0.2 | 0.3 | 0.3 |
| B | 0 | 0 | 0 | 0 | 0.1 |
| Ca | 0.1 | 0.1 | 0.1 | 0.1 | 0.1 |
| Cr | 0 | 0 | 0 | 0 | 0.2 |
| Cu | 0 | 0 | 0 | 0 | 0.2 |
| Fe | 0.5 | 0.4 | 0.5 | 0.4 | 0.2 |
| K | 0.4 | 0.05 | 0.03 | 0.02 | 0.1 |
| Mg | 0.1 | 0.06 | 0.1 | 0.1 | 0.1 |
| Mn | 0.2 | 0.2 | 0.2 | 0.2 | 0.2 |
| Na | 0.2 | 0.04 | 0.03 | 0.02 | 0.1 |
| P | 0 | 0 | 0 | 0 | 0.05 |
| Purity | 99.9998% | 99.99988% | 99.99988% | 99.99986% | 99.999% |

TABLE 7
Table 7. Impurities detected in bulk silicon sample

| | Si impurities | Si impurities | Si impurities | |
|---|---|---|---|---|
| | ppm | ppm | ppm | |
| ppm | Example 6 | Example 7 | Example 8 | SEMI III |
| Al | 34 | 0.5 | 0.1 | 0.3 |
| B | 2 | ND | ND | 0.1 |
| Ca | 0.3 | 0.2 | 0.1 | 0.1 |
| Cr | ND | ND | ND | 0.2 |
| Cu | ND | ND | ND | 0.2 |
| Fe | 5 | 0.4 | 0.2 | 0.2 |
| K | 0.5 | 1.0 | 0.05 | 0.1 |
| Mg | 2 | 0.1 | 0.05 | 0.1 |
| Mn | 4 | 0.3 | ND | 0.2 |
| Na | 0.5 | 0.9 | 0.02 | 0.1 |
| P | ND | ND | ND | 0.05 |
| Purity | 99.99% | 99.999% | 99.9999% | 99.999% |

As seen in Tables 5-7, the purities achieved are much higher than anticipated by the projected purities of the process of FIG. 1 and Table 3b. For example, the Aluminum and Calcium impurities are two orders of magnitude smaller than anticipated. Further, Boron, Phosphorus, and Titanium are not detectable. Still further, the iron quantities are more than an order of magnitude smaller than the process of FIG. 1. Furthermore, no reported values exist for Sodium or Potassium contamination. However, electric are furnace (EAF) processing at time periods of 6 h gives Sodium or Potassium contamination at 0.5-2 ppm which are reduced to 0.02 ppm if the process times are greater than 6 h because these elements, along with other alkali and alkaline earth metals, evaporate during the longer process times.

The EAF used in the Examples below is a 50 kW single top electrode direct current furnace using graphite walls. The inside of the walls, in contact with the RHA, and the silicon, do not react with graphite and are observed to remain intact after each application of the process, and thus do not contribute carbon to the reaction. Example 6 below shows that higher power and/or temperatures produce higher batch yields, but sometimes at the expense of purity.

The arc power settings, once operating temperature is reached, are from 7 kW to 20 kW, corresponding to 8-12 kWh of energy consumed per kg of feedstock at present scale. Scaled up to a 10 kg/h silicon production theoretical capacity, this represents a 44% increase in Si production rate (5.8 kg/h vs 4 kg/h for conventional feedstock) and a 13% reduction in energy costs (33.6 kWh/kg of Si vs 40 kWh/kg of Si for conventional feedstock).

By using purified RHA as feedstock, the amorphous silica is intimately pre-mixed with some carbon (carbon initially present in RHA before graphite addition) at the submicron scale. The time to complete reaction is controlled solely by the distance species in the largest particles must travel (diffuse) to reach the reaction zone (typically at the particle surface). Hence the larger the biggest particles are, the longer time it takes to get complete reaction. The following empirical formula, Equation (1), can be used as a guide to predict reaction times for solid-state reactions.

$$[ 1 + ( z - 1 ) x ] \frac{2}{3} + ( z - 1 ) ( 1 - x ) \frac{2}{3} = z + 2 ( 1 - z ) \frac{Kt}{{r}_{{A}^{2}}}$$

Equation 1 describes the time required for reactant A particles of radius r, and mole fraction x, to react given a global rate constant Kt for reaction, where z is the unit volume of product formed from a unit volume A. The latter accounts for changes in density. This formula is a relatively crude method of predicting solid-state reaction times because it does not consider phase changes, or impurities in primary particles, or aggregates. It does indicate that the production of Si0_{g}, should be faster when using RHA than by using the usual quartz and coal feedstock.

Si, O and C elemental mapping of the purified RHA was performed to confirm the nanometer scale mixing of the SiO₂ and C in RHA. As observed in FIG. 2, carbon and silicon atoms are relatively homogeneously dispersed in the RHA particles confirming the intimate mixing of the amorphous SiO₂ and C in the RHA. FIG. 2 also shows that the apparent individual particle sizes are approximately 50-100 nm in size.

In addition this intimate mixing results in very much smaller diffusion distances: the time to complete the transformation to silicon should be much faster meaning high throughput in a continuous reactor and or the potential to use a smaller EAF and less electricity to produce identical amounts as the processing times are reduced.

In a small scale EAF, most of Sio_{g} leaves the reaction zone. In the following examples, the high concentration of Si_{g} in the reactor results in a quantity condensing back into the reaction zone, as occurs in larger reactors. This explains the higher than expected yields. The high rate of SiO_{g} production probably also explains the high rate of conversion of the RHA to silicon. The rate of purified RHA consumption in the system is roughly 4× the rate expected compared to typical quartz/coal feedstocks. Even though currently the carbothermal reduction of silica to silicon only represents a small fraction of the price of final Siₚᵥ (Siₘₑₜ only costs $3/kg), a faster rate of conversion has some benefits. If these results are confirmed at industrial scales, energy losses as well as the amortizing cost of the capital equipment per kg of Si produced will be lowered.

All analyses were conducted using ICP-OES analysis of HF digested samples.

### Example 1

### Conversion of Purified RHA to Si Via EAF Carbothermal Reduction, Single Batch Process

4.3 kg of purified RHA (similar to Table 4 after complete process) was mixed with 615 g of high purity graphite powder, then 2.3 L of distilled water was added and the slurry was formed into 40-50 g spherical pellets. Pellets were dried for 8 h at 225° C. then placed inside the EAF. Power was quickly increased from the initial 2 kW to 16 kW at 200 kw/min; it took 6 h for all the RHA to react. 220 g of silicon was collected, analysis shown in Table 5 column 2. EAF used in these experiments is the 50 kW single top electrode direct current EAF using graphite walls described above.

### Example 2

### Conversion of Purified SDRHA to Si Via EAF Carbothermal Reduction, Single Batch Process

Silica depleted RHA (SDRHA) was prepared by reacting milled RHA (milled in 3.7 wt. % HCl, then washed in water, then neutralized using 10 wt. % ammonium hydroxide solution) in ethylene glycol (36.2 L) and catalytic amount of sodium glycolate silicate (3.94 mole of SGS) where 40 wt. % of the silica was extracted. SDRHA was then filtered, washed in water, then acid leached in 6.7 wt % HCL, then washed in boiling water. Pellets were dried for 8 h at 250° C. 265 g of high purity graphite powder was added and 3.2 L of distilled water was added and the slurry was formed into 40-50 g spherical pellets. Pellets were dried for 8 h at 250° C. then placed inside the EAF. Power was quickly increased from the initial 2 kW to 16 kW at 200 kw/min; it took 6 h for all the RHA to react. 110 g of silicon was collected. The analysis is given in Table 8 below.

TABLE 8
Analysis of Si produced from SDRHA. (all numbers based
on metal purity so C is not taken into account)

| Impurities | Al | B | Ca | Cr | Cu | Fe | Mg | Mn | K | Na | P | Purity |
|---|---|---|---|---|---|---|---|---|---|---|---|---|
| Si impurities | 0.4 | ND | 1.6 | ND | ND | 3.6 | 0.6 | ND | 1.7 | 1.2 | ND | 99.9990% |
| ppmw | | | | | | | | | | | | |

### Example 3

### Conversion of Purified RHA to Si Via EAF Carbothermal Reduction, Multi Batch Batch Process

9.5 kg of purified RHA (similar to Table 4 after complete process) was mixed with 1273 g of high purity graphite powder, then 7 L of distilled water was added and the slurry was formed into 40-50 g spherical pellets. Pellets were dried for 8 h at 225° C. ⅓ of the pellets were placed in the EAF. Power was quickly increased from the initial 5 kW to 11 kW in 30 minutes, after 4 hours power was reduced to 7 kW; another ⅓ of the pellets was added after 8 h, then the final third after 13 h. Total run time was 19 h. 350 g of silicon was collected, analysis shown in Table 6, column 2.

### Example 4

In this example, the same methods were used as in Example 3. The approximate yield was 600 g and the analysis is that given in Table 6, column 3.

### Example 5

In this example, the same methods were used as in Example 3. The approximate yield was 450 g and the analysis is that given in Table 6, column 4.

### Example 6

In this example, first 20 kg of RHA was milled twice (3.7 wt % HCl), washed with water and boiling water (BBW). 15.2 kg of pellets were formed and one-third of the pellets were placed in the crucible and the arc was started at 4 kW and increased to 15 kW after 30 min. A uniform but somewhat higher than normal operating temperature was reached after 5 h and 12 kW was required to keep the temperature stable. Another third of the pellets was added after 10 h with the final third added after 16 h. The total run was 22 h and gave approximately 1.4 kg of silicon and approximately 0.2 kg of SiC.

The production quantities at higher temperatures were more than double those of previous examples. However, the higher temperatures also generated more impurities from the supporting structure of the EAF at this level of production as seen in Table 7 yielding Si purity to 4 Ns as a result.

### Example 7

11.3 kg (dry weight, 15.6 kg actual weight) of purified RHA pellets were prepared for this run. ⅓ of the pellets were placed in the crucible and the arc was started at 4 kW and increased to 12 kW in 30 minutes. Operating temperature was reached after 5 hours and 9.5 kW was required to keep temperature stable (top of the furnace was slightly different to try to limit Al contamination). Another third of the pellets was added after 10 hour, and the final third was added after 16 hours. Total run was 21 hours. Once the EAF cooled down, 550 g of silicon was collected. The purity is 6 Ns per Table 7.

### Example 8

The run that gave the highest silicon purity (6 Ns) had a yield of 550 g (16% of theoretical yield): Initially 3.76 kg (dry weight) of purified and carbon adjusted RHA pellets (using Path 1) were placed in the crucible, after 10 h another 3.76 kg was added, then a final 3.76 kg after 16 h. Total arc duration was 21 h at which point the arc was shut and the system allowed to cool down before the silicon could be collected. The initial setting of the arc is 4 kW, increased to 12 kW in 30 minutes. The power was reduced after 5 h to 9.5 kW to keep temperature constant (1880-1930° C.). On cooling, 550 g of silicon was collected (16% of theoretical yield).

### Example 9

The run that had the highest yield produced 1.4 kg of silicon from 10.9 kg of RHA (dry weight) of Path 1 pellets (C:SiO₂ ration 1:1.65). One-third of the pellets were placed in the crucible, then the arc was started at 4 kW and increased to 15 kW after 30 min. A uniform but somewhat higher than normal operating temperature (temperature could only be measured reliably at the bottom exterior of the crucible: 2015-2040° C. vs. 1850-1930° C. for standard operation) was reached after 5 h and 12 kW was required to keep the temperature stable. Another third of the pellets was added after 10 h with the final third added after 16 h. The total run time was 22 h and gave ≈1.4 kg of silicon (37% of theoretical yield).

What is claimed is:

1. A process to produce high purity silicon comprising:
1) milling rice hull ash with an acidic solution to yield purified rice hull ash;
2) converting the purified rice hull ash to polycrystalline silicon by carbothermal reduction; wherein impurities in the polycrystalline silicon meet SEMI III standards.

2. The process of claim 1, further comprising the step of performing boiling water washes after the milling step.

3. The process of claim 1, wherein the process lacks production of chlorosilane intermediates and metallurgical grade silica.

4. The process of claim 1 wherein silica and carbon are intimately mixed at the submicron scale.

5. The process of claim 1, wherein the boiling water purification step is comprised of a plurality of washing and filtering steps performed in succession.

6. The process of claim 1, wherein carbothermal reduction occurs at between approximately 1400-2100° C.

7. The process of claim 1, wherein the step of converting by carbothermal reduction comprises adding batches of purified rice hull ash to a furnace.

8. The process of claim 1, wherein the step of converting by carbothermal reduction comprises intimately pre-mixing carbon in the purified rice hull ash with amorphous silica at the submicron scale.

9. The process of claim 8, wherein the intimate mixture of the carbon and the amorphous silica occurs in particles having a mean diameter between approximately 50-100 nm.

10. The process of claim 1, further comprising the step of performing directional solidification of the polycrystalline silicon.

11. The process of claim 1, wherein the SiO₂:C ratio of the purified rice hull ash is adjusted prior to carbothermal reduction.

12. The process of claim 11, wherein the adjustment is addition of carbon to the purified rice hull ash to yield an SiO₂:C ratio less than 2.1:1.

13. The method if claim 1, further comprising the step of extracting silica.

14. The method of claim 13, wherein the silica extraction step is performed by adding ethylene glycol.

15. A composition comprised of polycrystalline silicon made by the process of any of claims 1-14 and having a purity greater than 99.99%.

16. The composition of claim 15, wherein the purity is greater than 99.9999%.
